(19) United States
(12) Patent Application Publication
(10) Pub. No.: US 2011/0173023 A1
(43) Pub. Date: Jul. 14, 2011

(54) Method and System for Managing Organ Transplant Transporation

(75) Inventors: James LeClair, Covington, GA (US); Randal Miller, Gaithersburg, MD (US)

(73) Assignee: Gryphes Inc., Covington, GA (US)

(21) Appl. No.: 13/004,647

(22) Filed: Jan. 11, 2011

Related U.S. Application Data
(60) Provisional application No. 61/294,298, filed on Jan. 12, 2010.

(51) Int. Cl. A01N 1/02; G06Q 50/00; G06Q 10/00

(52) U.S. Cl. 705/2; 435/284.1

(57) ABSTRACT

The various embodiment methods and systems manage the transportation of high priority medical materials, such as harvested organs from the donor to the recipient, so as to ensure a secure, continuous and monitored transport of such materials. The management systems and methods of the various embodiments provide accountability and ensure the integrity of the organs during transportation by planning, managing and monitoring the organ transportation process. A transport device containing an organ in transit may provide status data to a centralized command center, which may in turn update the planned transplant process as necessary and communicate updates with participants. A command center provides overall management, monitoring and reporting of the transportation status to participants via SMS, email or other messages

### RELATED APPLICATIONS

This application claims the benefit of priority to U.S. Provisional Patent Application Ser. No. 61/294,298 entitled “Method and System for Managing Organ Transplant Transportation” filed on Jan. 12, 2010, the entire contents of which are hereby incorporated by reference.

### BACKGROUND

There are about 100,000 people in the United States alone who need an organ transplant. The average number of yearly human organ transplants in the United States is about 28,000. These organ transplants are performed by the 50 university based facilities capable of performing transplants. But, today there is a shortage of donor organs and tissues. Further, every organ has time limitations for viability, making time of the essence for removal and transplantation. Therefore, it is important that the organs or tissues that are identified as a match reach the intended recipient safely and without damage.

Currently, organ transplantation requires communication and coordination between all parties at each stage of the process. This includes hospital teams on the donor and receiving sides, as well as outside vendors such as drivers, pilots and other members of a transport team, each of which must each independently coordinate with multiple other parties. The existing communication systems are therefore inefficient, prone to errors, and expensive. Further, errors in this system may result in catastrophic outcomes with respect to the recipient's health, as well as the loss of the donated organ.

### SUMMARY

The various embodiments provide devices, methods and systems for managing the transportation of harvested organs from the donor to the recipient so as to ensure a secure, continuous and monitored transport of such organs anywhere in world. The various embodiments provide a centralized command center to communicate with transplant and harvesting teams, coordinate transportation of an organ from one hospital to another, and receive status data directly from the device transporting the organ. The command center may thus ensure the safety and security of an organ in transport and automatically make critical updates to a planned transplant procedure if necessary.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention.

FIGS. 1A-1D are perspective views of an organ transport device according to the various embodiments.

FIG. 1E is a perspective view of cooling components of an embodiment organ transport device.

FIG. 1F is a cross section view of an inner caddy component of an embodiment organ transport device.

FIG. 1G is a perspective view of the interior components of an embodiment organ transport device.

FIG. 1H is a perspective view of the interior components of an embodiment organ transport device.

FIG. 2 is a component block diagram of communicating parties in an organ transplant process.

FIG. 3 is a component block diagram of an organ transplant system according to the various embodiments.

FIG. 4 is a communication network diagram for an organ transplant system according to an embodiment.

FIG. 5 is an example data table of a harvest/transplant plan for an organ transplant process according to an embodiment.

FIG. 6 is an example updated data table of a harvest/transplant plan for an organ transplant process according to an embodiment.

FIG. 7 is a diagram of a chain of custody model for a single organ transplant process according to an embodiment.

FIG. 8 is an example chain of custody data table for a single organ transplant process according an embodiment.

FIG. 9 is a data table including data for all managed organ transplant processes according to an embodiment.

FIG. 10 is a process flow diagram of an embodiment method for managing an organ transplant process.

FIG. 11 is a process flow diagram of an embodiment method for communicating with an organ transport device.

FIG. 12 is a process flow diagram of an embodiment method for communicating with an organ transport device.

FIG. 13 is a component block diagram of an example organ transport device suitable for use with the various embodiments.

FIG. 14 is a component block diagram of a laptop computer suitable for implementing the various embodiment methods.

FIG. 15 is a component block diagram of a server suitable for implementing the various embodiment methods.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “organ” is used herein to mean any controlled medical support product or biological substance such as organs, tissues, biological specimens or other medical products that require special conditions during transport.

The outcome of organ transplant surgeries depends on the quality of the organs that are transplanted into the body of the organ recipient. Intrinsic or extrinsic factors may affect the quality of donated organs. Intrinsic affects may include malformations or diseases rendering the organ incompatible for transplantation. Extrinsic factors include environmental factors, such as the length of time an organ remains outside of the body and devoid of nutrients, mishandling of the organ such as dropping and bruising it, the temperature range the organ is exposed to outside of the body, and exposure to chemicals or other substances that may cause damage to the organ at the cellular level. While intrinsic factors are difficult to control, many of the extrinsic factors can be managed to reduce damage to the donated organ from the period of harvest to transplant.

The optimal situation for managing extrinsic factors is when both the harvest and transplant of the organ occurs within the same hospital. In such a scenario, a surgeon may harvest the organ from the donor and a second surgeon within the same hospital and within a very short amount of time may transplant the organ into the recipient. Accordingly, the journey of the organ outside of the body is brief. However, such scenarios rarely occur. Because the organ transplant network monitors patients all around a country and sometimes in different countries, matches may be found at disparate locations which may sometimes be separated by 24 hours of transportation time.

When donors and recipients are in different locations, the extrinsic factors must be managed in the process of transporting organs from the donor to the recipient. For example, to preserve the integrity and quality of organs, they must be transported under certain strict conditions. Many organs must be maintained at a temperature between 1° C. to 10° C. Also, care must be taken not to drop the organ or the container to prevent physical damage, such as bruising of the organ. Further, because a black market exists for donated organs, security issues relating to transporting the organs are very important.

In addition, in paired donor situations, a first donor and recipient may be located at one hospital and a second donor and recipient maybe located at second location. Accordingly, the harvesting of organs may be done in parallel at the same time or they may be done at different times. In other situations, each donor or recipient may be at a different hospital, causing four different hospitals to be involved in this process.

The various embodiment devices, methods and systems to facilitate the transportation of organs and the transplant process. Employing the various methods and systems may enhance the decision-making process, reduce or prevent delays or losses of critical payloads during transportation, increase security in transporting organs, and improve transplant morbidity and mortality in patients. The various embodiments also facilitate communication, management and coordination during paired donations.

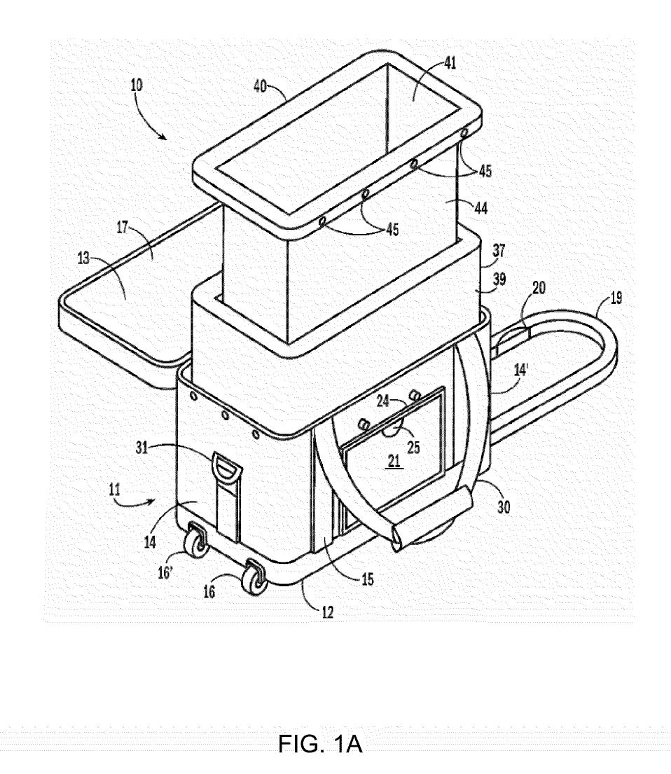

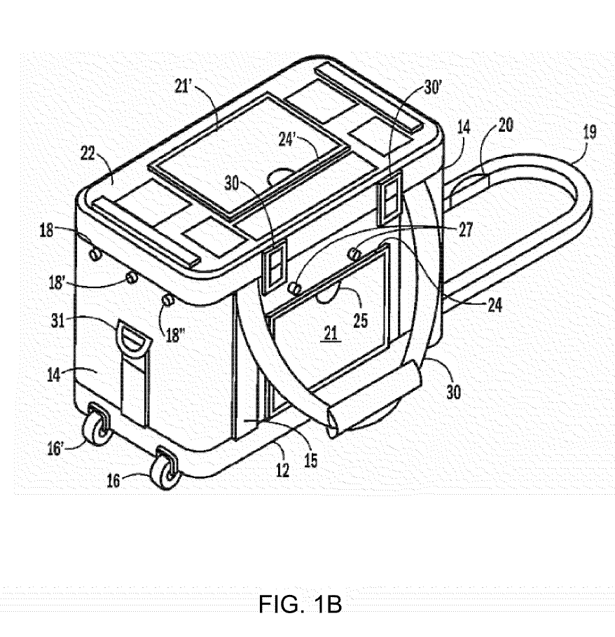

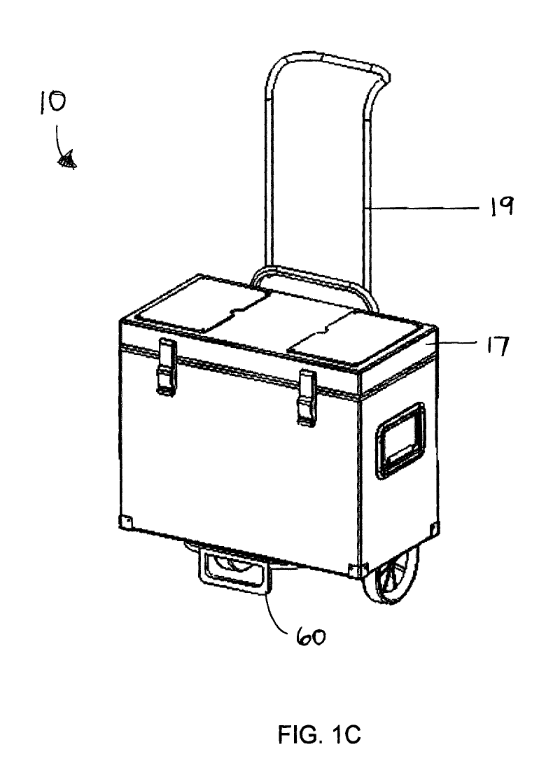

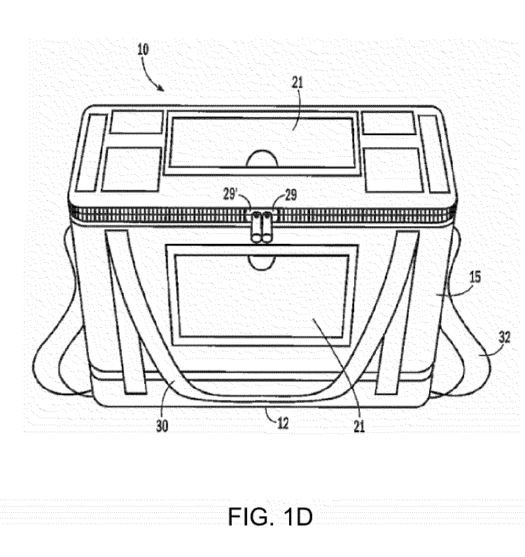

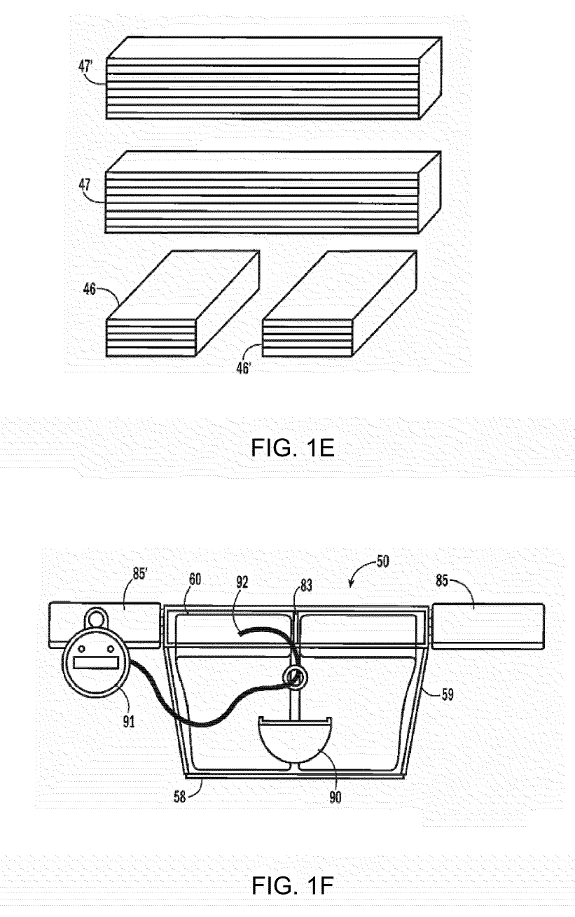

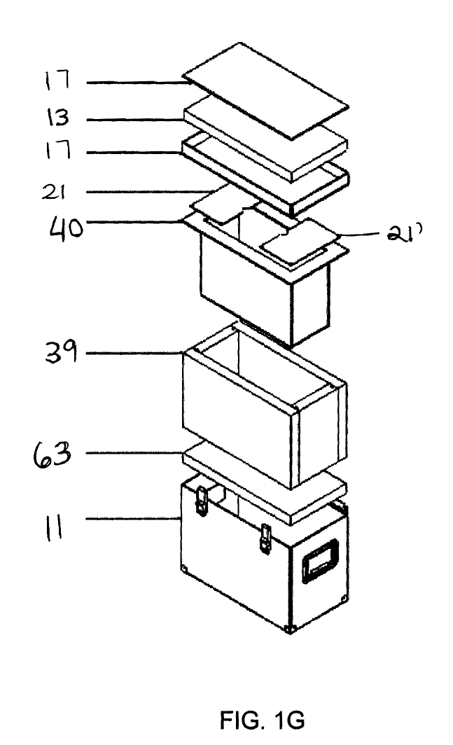

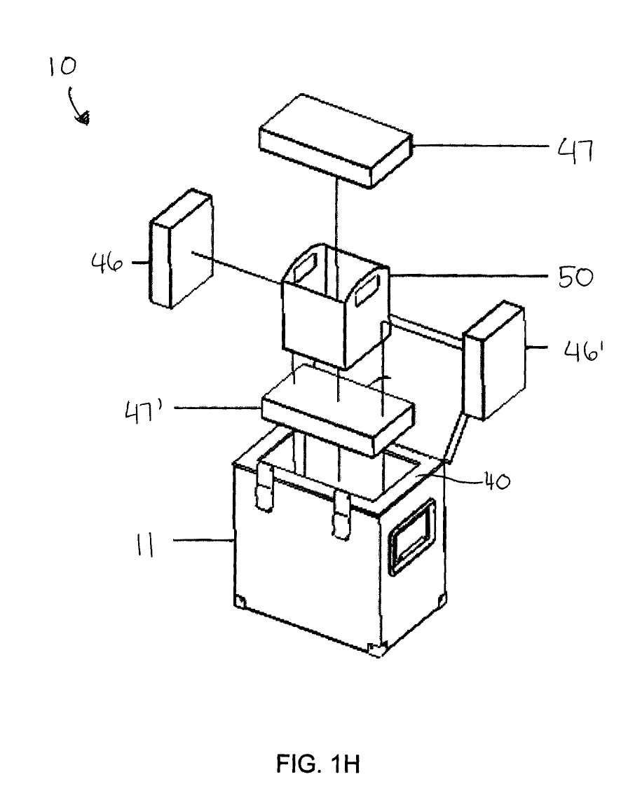

FIGS. 1A and 1B illustrate an embodiment organ transport device. The organ transport device 10 may include an outer case 11, an insulating layer 37, and a waterproof open well 40. The outer case 11 may be made of a flexible, lightweight material such as ballistic nylon, vinyl or canvas, or a hard rigid material for more durability, or any other suitable materials generally known and used by persons skilled in the art. Preferably, the outer case 11 may be constructed from a waterproof, stain resistant, rustproof material that can be easily cleaned. The outer case 11 may be adapted to form a receptacle area for an insulating layer 37 made of suitable insulation materials to shield the interior contents of the organ transport device 10 from external temperature. Suitable insulation materials may include a substantially rigid insulating material having a relatively low thermal conductivity and being relatively light weight, for example Minicel®, Volara®, Neoprene, Polystyrene (Styrene), Polyethylene, VIP (Vacuum Insulation Panel), ABS and Coroplast®, TempShield™ and SPACE AGE®. In a preferred embodiment, the insulating layer 37 may be formed from rigid polyurethane. In an alternative embodiment, the insulating layer 37 may be formed from closed cell PE foam, and may be formed of the same material as the interior 13 of the lid 17.

The organ transport device 10 may be made in different sizes depending on the number, weight, and/or volume of the contents that are being transported. Contents that may be transported using an organ transport device according to the various embodiments include, but are not limited to, donated organs (e.g., a kidney), tissues, biological specimens, blood, plasma, serum, and pharmaceuticals that require temperature controls and close monitoring. Thus, references herein to an organ transport device are not intended to limit the scope of claims to the transport of organs.

In an embodiment, the organ transport device 10 may include one or more vertical dividers that may be used in transporting multiple units of the same content (e.g., multiple units of blood or blood products), and may enable the device to hold a caddy rack of serum specimens in transfer tubes. The organ transport device 10 may also be modified with a horizontal divider to hold two different contents, for example, two organs in transit to the same location.

The outer case 11 may include at least one identification sleeve 21 which is adapted to secure and hold documentation concerning the organ or other item being transported. For example, in a transportation of blood or blood products the documentation may include information such as a patient's name, social security or identification number, physician, blood type, date the blood or blood product left the blood bank, scheduled date of delivery, number of units of blood or blood product being transported, delivery destination, etc. The identification sleeve 21′ may be made of a clear or transparent plastic with an opening 24 and finger notch 25 for easy insertion and removal of documentation.

The insulating layer 37 may include a bottom portion 38 connected to walls 39, which may be adjacent to the inner perimeter of the outer case 11. The insulated layer 37 may have a predetermined height to substantially engage or abut the top of the organ transport device 10 while substantially minimizing the air space remaining above the organ.

In an embodiment, the interior layer 13 of the lid 17 may have a closed cell PE foam insert that acts as insulation to prevent the transmittal of external heat, thus protecting the interior contents of the organ transport device 10. It will be appreciated that any suitable insulating material may be used in the interior layer 13. The interior layer 13 may also act as a water barrier to protect the interior contents of the organ transport device 10. In an alternative embodiment, a cooling module may be added to the interior layer 13 in which coolant material may be disposed, further enhancing the performance of the container 11.

The waterproof open well 40 may be made of PE plastic and surrounded by the insulating layer 37. The well 40 may form a receptacle area 41 for cooling elements, discussed in further detail below with respect to FIG. 1D. The well 40 may be inserted in the outer case 11 to substantially engage the walls 39 of the insulating layer and bottom portion, so as to seal the insulated layer 37 to the outer case 11. In an example embodiment, the well 40 may be secured to the outer case 11 by anchor screws 45. It will be appreciated by those skilled in the art that other securing means such as nails, glue, nuts and bolts may be applied to secure the well 40 to the outer case 11, or that the well 40 may, in alternative embodiments, be removable from the outer case 11 to facilitate cleaning.

In an embodiment, a wheel assembly 16, 16′ and anchor screws 18, 18′, 18″ may be attached on one of the ends 14 of the organ transport device 10, thereby providing a stabilizing mechanism for the device when stood on its end 14. Other example stabilizing mechanisms may include a foot, a claw or any other stabilizing mechanism that is generally known and used by those of ordinary skill in the art. A telescopic handle 19 may be provided on an end 14′ to enable pulling the organ transport device 10 on the wheel assembly 16, 16′. The telescopic handle 19 may be capable of gradually extending to the desired height from end 14′ when a push button 20 is pressed. The push button 20 may also retract the telescopic handle 19 when pressed. FIG. 1C illustrates an alternative embodiment organ transport device with a stabilizing mechanism. A stabilizing foot 60 may extend from the bottom of the organ transport device 10, and a telescopic handle 19 may extend from the lid 17. The foot 60 and the telescopic handle 19 may be formed in a continuous piece.

The lid 17 of the organ transport device 10 may be hingedly attached to the side 15 of the outer case 11, and may be latched closed by twist latches 30, 30′. Preferably, at least one twist latch 30 is lockable. Alternatively, other suitable forms of closing mechanisms may be used, such as hooks, loops, snap fasteners, buttons, Velcro, zippers, etc. For example, FIG. 1D illustrates an embodiment organ transport device with a lid that may zip closed. The lid 17 may be configured with at least one zipper 29, 29′. In another embodiment, a zipper 29 may extend around the entire periphery of the lid 17 such that the lid 17 is completely removable. In another embodiment, the lid 17 may have a zipper 29 extending around the two ends 14, 14′ and one side 15, such that the lid 17 may be hinged at its attached side 15, thereby providing maximum opening without being completely removable.

Base 12 of the organ transport device 10 may include a rigid base insert covered with a flexible material. In a preferred embodiment, the flexible material may be ballistic nylon. The outer case 11 may also have rings 31 to attach shoulder strap 32, thereby facilitating picking up and carrying the organ transport device 10. In an alternative embodiment, an additional reinforced handle (not shown) may be attached to the top of the lid's exterior 22, providing yet another mechanism for picking up and carrying the organ transport device.

FIG. 1D illustrates cooling components within the waterproof open well 40 of FIG. 1A, according to an embodiment. The well 40 may be formed from PE plastic components, and may form a receptacle area 41 for cooling elements 46, 46′, 47, 47′. FIG. 1E illustrates an inner caddy in an embodiment organ transport device 10. The inner caddy 50 may include a receiving area 90 sufficiently wide and deep enough to hold and secure a data-logging device 91. The data-logging device may be configured to measure and record, for example, temperature of the contents of the organ transport device. In a preferred embodiment, the receiving area 90 may be secured to the front wall 81 of the inner caddy 50. However, it will be appreciated by one of ordinary skill in the art that the receiving area 90 may be located anywhere on or near the inner caddy, provided that the data-logging device 91 is set in close proximity to the contents being transported.

The data-logging device 91 may comprise at least one probe 92, or sensor, for monitoring, collecting and reporting data concerning the items being transported. The probe 92 or sensor may be inserted into a protected channel formed in the caddy 50, proximate to the items being transported. The data-logging device 91 may be a programmable processor and may be adapted to monitor, for example, the temperature of the items being transported for 24 hours or more to meet the courier or recipient's protocols. In this manner, compliance with transportation requirements (e.g., the extrinsic factors discussed above) may be documented and verified. The data-logging device 91 may include a connection point to enable it to be connected to a computer docking station for downloading the data, or may connect with a computer wirelessly. The data may be downloaded into suitable software to produce a graph showing the trend in the measured parameter over time. In an alternative embodiment, the data-logging device 91 and/or the probe 92 may be incorporated into the caddy 50.

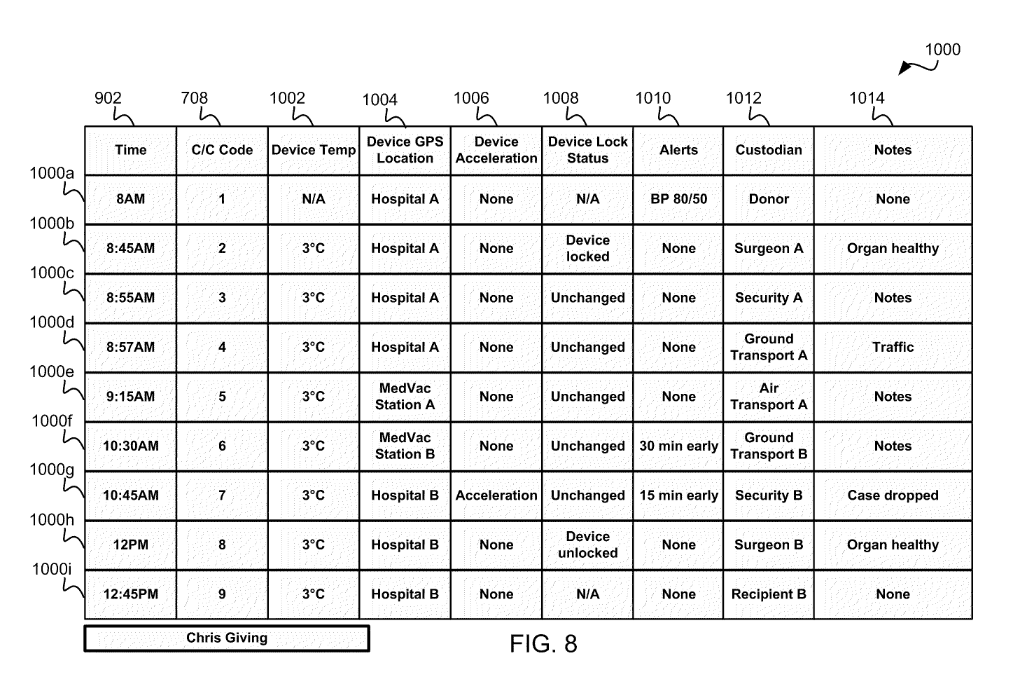

As described in more detail below with respect to FIG. 8, the data-logging device 91 may record more than just temperature, including location, time, accelerations, container opening events, and other sensor recordings (e.g., chemical sensors). In this manner, the data-logging device 91 may be configured to receive and record data from any form of sensor employed for monitoring the extrinsic factors managed in the transport of an organ or other contents.

FIG. 1G illustrates interior components within the outer case of an organ transport device, according to an embodiment. The organ transport device 10 may be sized to transport multiple contents, for example, two organs. The outer case 11 may hold insulating walls 39 and bottom 63, which may hold the waterproof open well 40. Identification sleeves 21, 21′ may be included over the well 40 to hold documents accompanying the organs(s) or other contents transported. For example, two identification sleeves 21 may be provided in an organ transport device 10 configured to hold two organs. The lid 17 may contain an insulating layer 13.

FIG. 1H illustrates interior components within the waterproof open well of an organ transport device, according to an embodiment. The waterproof open well 40 may fit securely within the outer case 11 and insulating layer (not shown). Inner caddy 50 and surrounding cooling elements 46, 46′, 47, 47′ may be contained in the well 40. The inner caddy 50 may be configured with hand cutouts to facilitate lifting from the well 40.

Methods for cooling, maintaining a constant cold temperature, and registering and storing the temperature of the interior of the organ transport device 10 are described in detail in U.S. Published Patent Application No. 2007/0028642, the entire contents of which are hereby incorporated by reference.

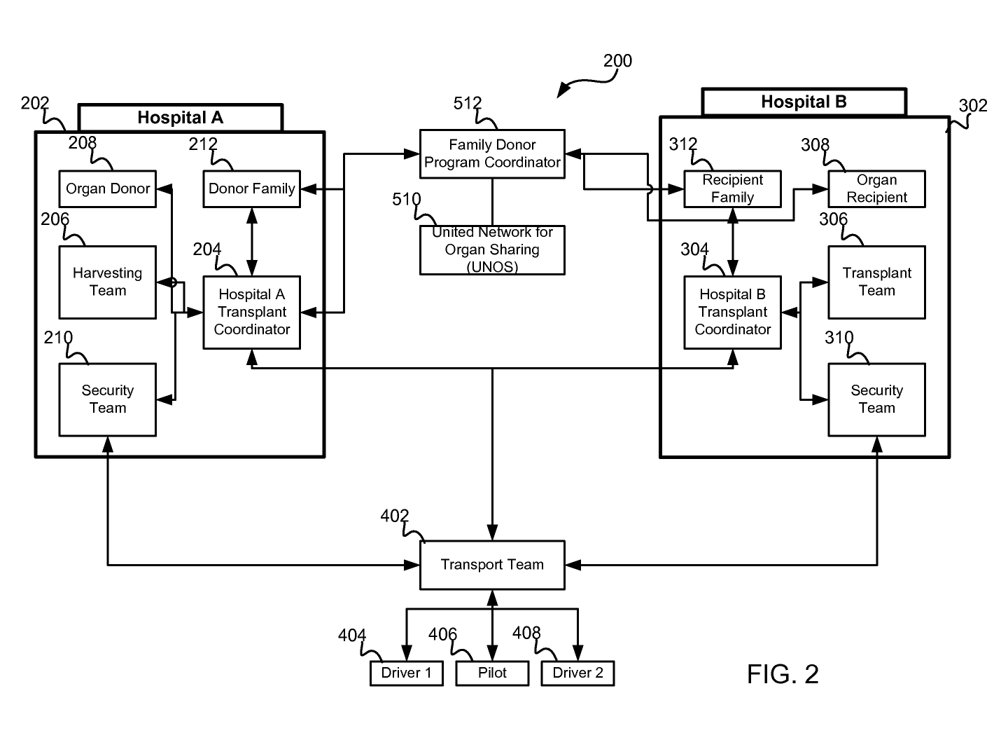

FIG. 2 shows a communication scheme for the multiple parties involved in transporting a harvested organ from the donor hospital to the recipient hospital. In example scheme 200, transportation of an organ from Hospital A 202 to Hospital B 302 may involve multiple components or participants communicating with one another. For example, the family donor program coordinator 512, with collaboration of the United Network for Organ Sharing (UNOS) 510, manages the matching of organ recipients to donors. Once a donor 208 is identified, the family donor program coordinator 512 communicates with the donor hospital 202 (Hospital A) and the recipient hospital 302 (Hospital B) to coordinate the transplant effort by setting a date and reserving the required staff and equipment for the transplant process.

To perform the harvesting of an organ, Hospital A 202 may include a transplant coordinator 204, a harvesting team 206 comprised of physicians and support staff and a security team 210 which ensures the safe transport of the organ from Hospital A 202 to the transport team 402. Hospital B 302 may host the recipient 308 and the recipient's family members 312. To perform transplantation of a harvested organ, Hospital B 302 may include a transplant coordinator 304, a transplant team 306 comprised of physicians and nurses, and a security team 310 which ensures the safe transfer of the harvested organ from the transport team 402 to the transplant team 306.

Before, during and after the harvesting, transport and transplant of an organ, the Hospital A and Hospital B transplant coordinators 204, 304 communicate with one another and the members of their team to ensure that the process is done without errors or delays. In this example, the Hospital A transplant coordinator 204 must coordinate the availability of the harvesting team 206, the preparedness of the security team 210 and the timely arrival of the transport team 402. At the same time, the information that is gathered at Hospital A 202 must be communicated to Hospital B 302, so that the Hospital B transplant coordinator 304 can coordinate and monitor timely arrival of the recipient 308, the recipient family 312, the transplant team 304 and the security team 310 before the organ arrival.

Under the present systems, each individual participant, coordinator or component at each hospital must also be in communication with other participants, coordinators and components of the system. For example, the harvesting team 206 must be in communication with the security team 210 to ensure that they are present during the hand-off of the organ to the transport team 402. The security team 210 must be in communication with the transport team 402 to ensure that they will accompany them to the operating room where the organ is picked up.

Outside vendors such at the transport team must also coordinate their efforts with each hospital and each component within each hospital. For example, a first driver 1 404 must independently communicate with the Hospital A transplant coordinator 204, the security team 210, and the pilot 406. The pilot 406 must independently coordinate time of takeoff with both Hospitals A and B 202, 302, and drivers 1 and 2, 404, 408. A second driver 2 408 must independently coordinate his arrival time with Hospital B transplant coordinator 304, the security team 310 and the pilot 406.

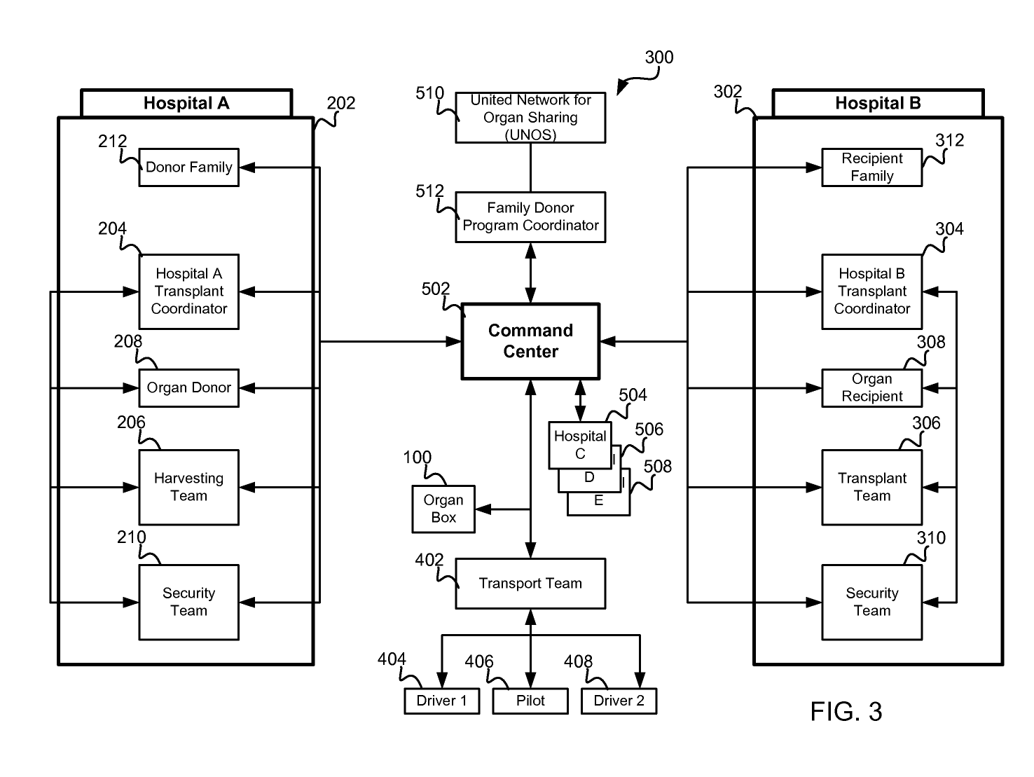

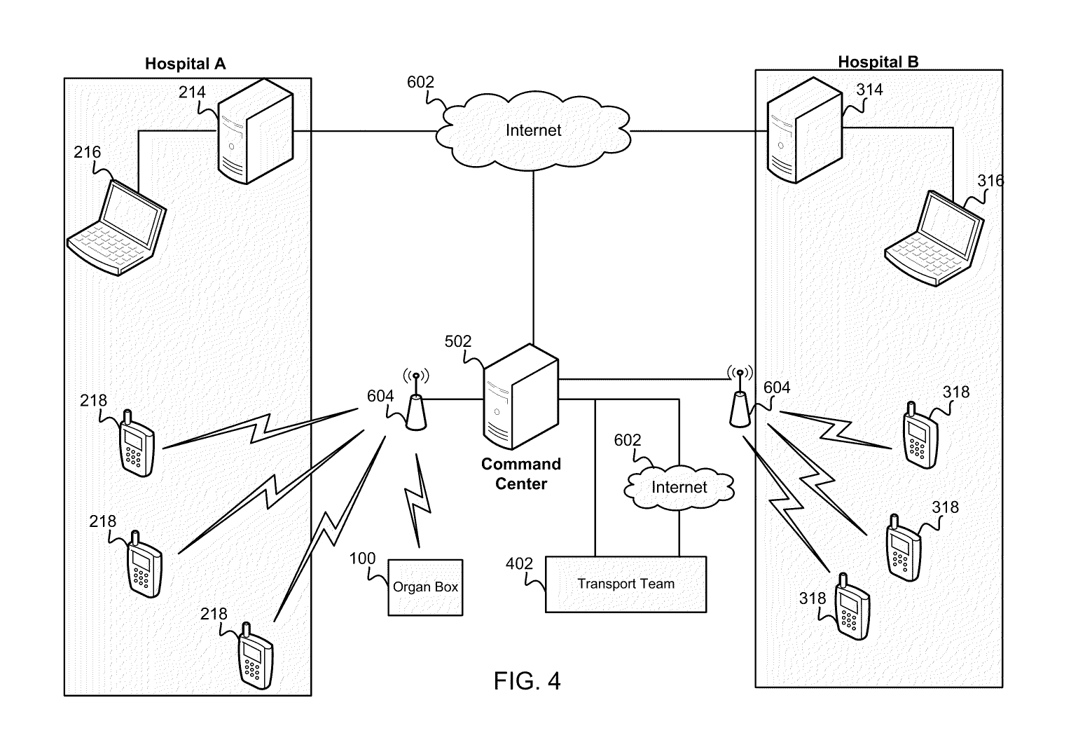

FIG. 3 illustrates a communication system for managing and monitoring the transplant process according to the various embodiments. A command center 502 may be configured to coordinate the transplant process and to manage all communications between different components. The command center 502 may receive data from each component of the organ transplant system, create a harvest/transplant plan and a chain of custody plan base on the data received, establish communication with each system component and participant, and implement the plans by continuously updating the plans based on communications with each system participant. The command center 502 may include one or more servers configured with connections to the Internet and to other communication networks to enable computer-to-computer communications, computer displays coupled to the servers to support a human operator, and telephones sufficient to enable one or more individuals to effect the coordination of the transplant evolution. In order to simplify the description of the various embodiments, reference is made to the command center 502 instead of specific components within the center. Thus, a reference to the command center 502 in the context of computer manipulation or communication of data will be understood to be a reference one or more servers within the command center (as is specifically the case in the description of FIG. 4).

In such a centralized system, instead of arranging communications with every other system component, each component may communicate with the command center 502. For example, the Hospital A transplant coordinator 204 may create a harvesting plan including the details of the harvesting process and communicate that plan to the command center 502. A harvesting plan may include information such as the type of surgery, donor's identification and contact data, donor's family members' identity and contact data, the identity and contact data of the harvesting team members, identity and contact data of the security team members, the date and time at which the harvesting procedure will take place and the time the harvested organ should be picked up by the transport team.

Similarly, the Hospital B transplant coordinator 304 may create a transplant plan and communicate that plan to the command center 502. A transplant plan may include data such as the type of surgery, recipient's identification and contact data, recipient's family members' identity and contact data, the identity and contact data of the transplant team members, identity and contact data of the security team members, the date and time at which the transplant procedure will take place.

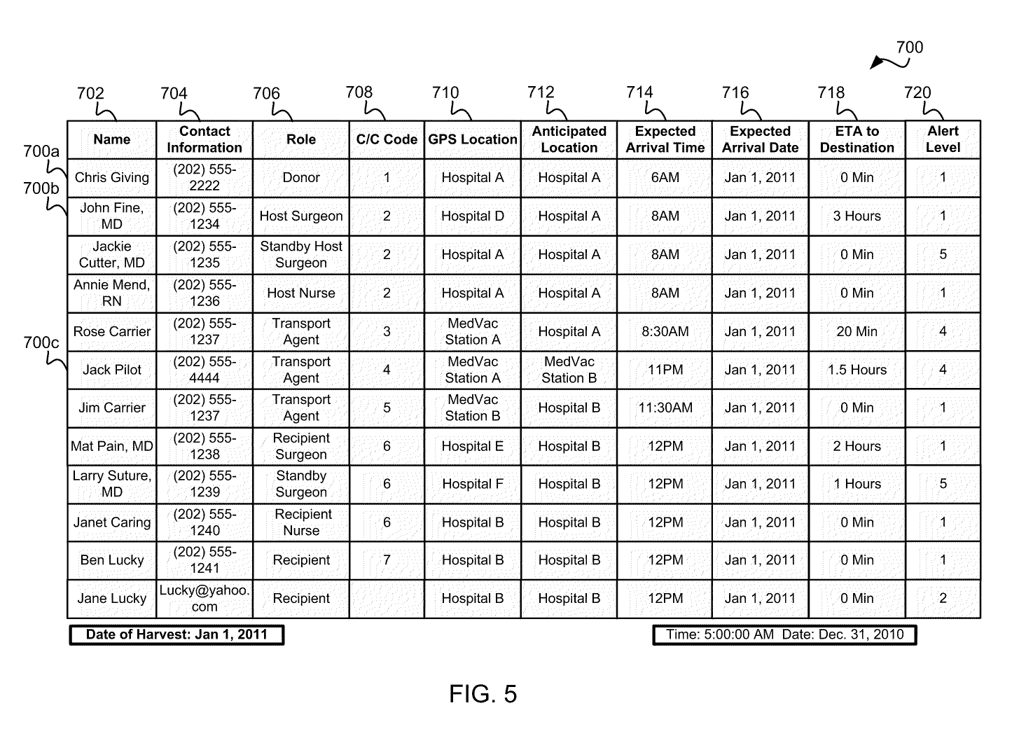

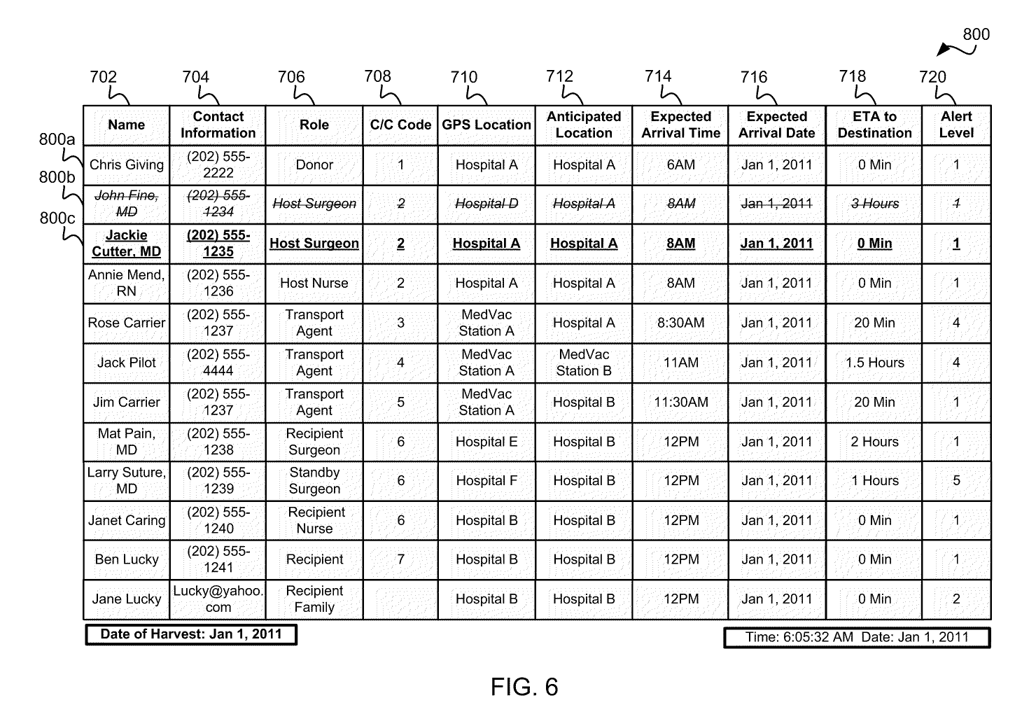

Using the harvesting and transplant plans received from Hospitals A and B 202, 302, the command center 502 may generate a comprehensive harvest/transplant plan. The harvest/transplant plan may include all or some of the data from each harvesting and transplant plan and additional data ascertained by the command center 502. An example of a harvest/transplant plan data structure is discussed in more detail below with reference to FIGS. 5-6.

A transport team 402 may be contracted by either Hospital A or Hospital B 202, 302. In such a scenario, the transport team 402 members' identities (e.g., driver 1 404, pilot 406 and driver 2 408) and contact information may be included in the harvesting or transplant plans. If such transport team data is not provided in the harvesting or transplant plans, the command center 502 may communicate with a transport team 402 to determine whether they will be available to pick up the harvested organ at the identified date and time. If a transport team 402 is available to participate in the transportation of the donated organ, the command center 502 may include the transport team members' identity and contact information in the harvest/transplant plan.

In a preferred embodiment, the command center 502 may further be in communication with the family donor program coordinator 512 and the UNOS 510 and receive and share information from each of these entities. Information that may be received from these entities may also be implemented into the harvest/transplant plan. The command center 502 may further receive data from the organ transport device 10. For example, the organ transport device 10 may include a processor configured to retrieve data from built-in sensors such as a thermometer, accelerometer and/or Global Positioning System receiver device and transmit that data to the command center 502 via a built in wireless transceiver (e.g., a cellular data network transceiver).

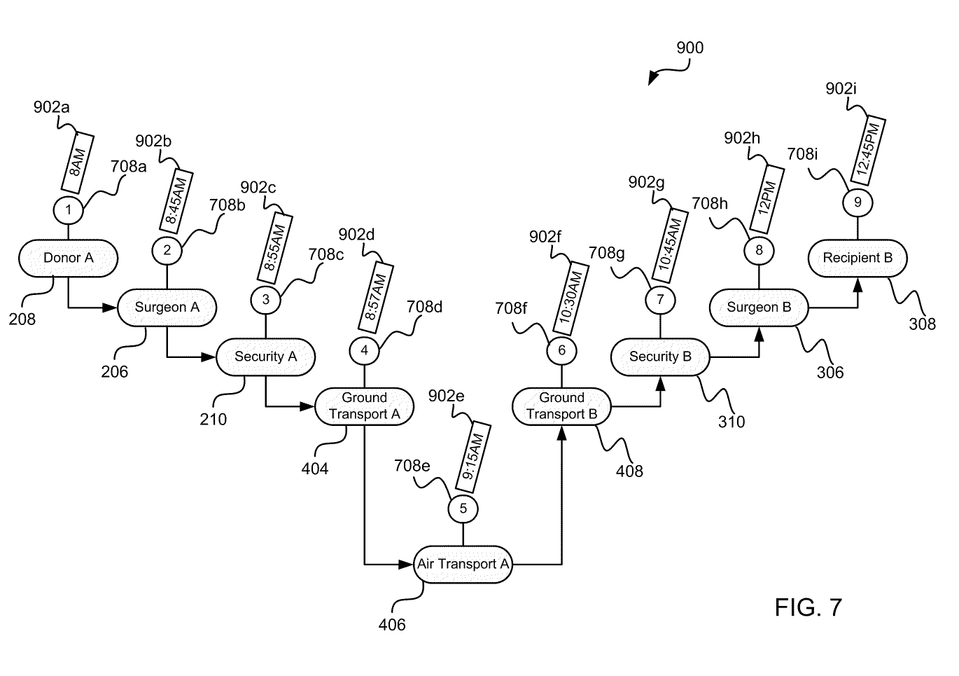

In the various embodiments, in addition to creating an initial harvest/transplant plan the command center 502 may employ the data received from different components of the transplant process to create an initial chain of custody model. This chain of custody model may represent the optimal circumstances under which the donated organ may be transported from the time it is harvested to when it is transplanted into the body of the recipient. The command center 502 may create a chain of custody plan based upon the data from the chain of custody model. The chain of custody model and plan are described in more details below with reference to FIGS. 7-8.

In the various embodiments, the harvesting plan, transportation plan, chain of custody plan, and other plans used to coordinate, manage, track and record events associated with a transplant evolution may be stored in electronic data tables maintained by one or more servers. Maintaining the various plans and custody documents in electronic data tables may enable the command center 502 to continuously update the documents while providing all authorized participants and components to have access to the information (or at least the information for which they have authorization). Additionally, the use of electronic plans and records within the command center 502 may enable status communications to participants to be achieved automatically as necessary and appropriate based upon the participant's or component's role in the overall evolution.

In the various embodiments, the command center 502 may continuously update the harvest/transplant plan and the chain of custody model and plan from the time they are created until the end of the transplant process. For example, a server within the command center 502 may continuously receive data from the Hospital A transplant coordinator 204 about any changes, such as changes in the composition of the harvesting team, date of harvest, time of harvest, or availability of the donor. The command center 502 server may reflect these changes in the harvest/transplant plan and the chain of custody model and plan by changing the parameters and data stored in those plans based on received changes. The command center 502 server may then re-create, modify or update the harvest/transplant plan and the chain of custody model and plan, and communicate and make available the new data for access by all the involved parties (e.g., via the Internet), as well as communicate time-critical information and reports to key participants (e.g., surgical teams, transportation teams, recipient family, etc.).

Changes to the harvest/transplant plan and chain of custody model and plan may occur before and during the transplant process. For example, several days before the harvest date, the Hospital A transplant coordinator 204 may inform the command center that the harvesting surgeon will not be able to perform the surgery on the date of harvest and he is being replaced by another surgeon. The command center 502 may reflect that change in the harvest/transplant plan and the chain of custody model and plan and communicate and/or display this change to the donor, the recipient and the other components of the transplant system. For example, access to the harvest/transplant plan may be provided to the donor 208 through an Internet webpage hosted by a server within the command center 502. By accessing such a webpage, the donor may continuously check for any updates or changes to the transplant process.

In the various embodiments, the harvest/transplant plan and the chain of custody model and plan may also be changed during the transplant process. For example, driver 1 404 may be involved in an accident while driving to pick up the harvested organ. In such a scenario, the command center 502 may receive direct communication from the driver 1 404 or from the employer of the driver 1 404 about such an accident. The command center 502 may communicate with a standby driver who may be able to complete the pick-up of harvested organ form the Hospital A 202 and deliver it to the pilot 406 in a timely manner.

In the various embodiments, the command center 502 may communicate with several different hospitals (e.g., Hospital C 504, Hospital D 506 and Hospital E 508) to coordinate different unrelated transplant processes. Accordingly, the command center 502 may manage and coordinate the harvesting/transplant process and transport of donated organs between different hospitals for different cases.

FIG. 4 shows a network diagram of an embodiment organ transplant communication system. The command center 502 may communicate with different components of the transplant system via data networks, such as the Internet 602, as well as telephonically via landlines (POTS) and cellular telephone networks. For example, participants may use cellular phones 218, 318 to call the command center 502 to inform an operator about a change that has occurred or simply to provide status. Cellular calls may be received by wireless access points 604 and the calls may be directed to the command center 502. The command center 502 may also communicate with servers 214, 314 of Hospitals A and B, respectively.

In a preferred embodiment, the command center 502 may also send and receive electronic messages, electronic mail and cellular simple message system (SMS)/multimedia message system (MMS) messages via a cellular network 604. For example, the command center 502 may send SMS messages to driver 1 404 periodically and expect to receive a response SMS message shortly thereafter. If no response SMS message is received from the driver 1 404 within a certain time period, the command center 502 may communicate with another driver to arrange for pick up of the harvested organ. SMS messages may also be used to automatically send out frequent periodic status updates to team members (e.g., members of the surgical team and recipient family member) to keep them informed through their cellular telephones.

In an embodiment, the command center 502 may also receive electronic messages, electronic mail and cellular simple message system (SMS)/multimedia message system (MMS) messages from a hospital. For example, the command center 502 may receive email from the Hospital B transplant coordinator that the recipient is sick and cannot undergo surgery on the harvest date. The command center 502 may then communicate with all other components of the transplant system, update the harvest/transplant plan to cancel the harvest and reschedule for another date. Emails may be sent and received via connections with the Internet 602. Since many people can receive email on their mobile devices (e.g., smart phone and Blackberry® devices), email may also be used to send out frequent periodic status updates to team members.

In a preferred embodiment, the command center 502 may receive GPS data from different components of the transplant system and effectuate changes to the harvest/transplant plan and the chain of custody based on the GPS data received. For example, the mobile device 218 of the harvesting surgeon may include a GPS receiver, so the mobile device may be configure to automatically obtain location data and communicate such data to the command center 502 via cellular networks 604. Such automatic location reporting capabilities may be used by the command center 502 to automatically manage the various plans. For example, if the location data received from the surgeon mobile device indicates he is too far from Hospital A to be able to arrive on time to harvest the organ, this can be recognized automatically by the command center 502 server, which may then automatically alert a standby surgeon to be present at the time of harvest (e.g., via SMS and/or email) and also communicate this change to all the components of the transplant system, such as via SMS, email and changes posted on a hosted website accessible by members of the transplant team. In this example, once the primary surgeon is replaced, he may also be sent a message (e.g., via SMS and/or email) informing him that he is no longer required because a standby surgeon has taken his place. GPS information may also be received from the organ transport device 10. GPS information may be transmitted by participants to the command center 502 via cellular networks 604, as well as the Internet 602.

The command center 502 may also provide users with access via the Internet 602 to a website hosted by a server for presenting the information that team members require to perform their roles. Updates to the harvest/transplant plan and the chain of custody document (e.g., reporting the current location and custodian of the organ) may be posted on the website by the command center 502, so those with access authorization can receive up to the minute information. In an exemplary embodiment, the command center 502 may allow certain entities (e.g., the hospital transplant coordinator) to make updates to the harvest/transplant plan and the chain of custody model via a web browser interface (e.g., a data entry page), while others may only view the information. Any update received by the command center 502 server via the website may be automatically communicated to the appropriate parties through web page updates and electronic message (e.g., via SMS and/or email).

FIG. 5 illustrates an embodiment data table for storing information that makes up an initial harvest/transplant plan. In example data table 700, column 702 may contain the names of parties involved in the transplant process. The name may be of an individual or a department in an entity. For example, column 702 may include the name of the donor, the name of the harvesting surgeon, or the name of the transport agent who will pick up the harvested organ from the hospital. Each name may be associated with contact information in column 704, which may be used to contact that entity. Contact information may include telephone or cellular phone numbers, email addresses, home addresses and any other data by which communication may be directed or sent to that entity. Column 706 may contain the role of each named party in data table 700, for example, donor, host surgeon, host nurse, transplant agent, pilot, recipient surgeon, recipient, recipient's family, etc. In column 708, each party may receive a chain of custody code (or “priority code”), which may represent the status, priority or role of that party in the chain of custody. For example, the donor 208 may be allocated a chain of custody code of “1”, the host surgeon may be “2”, the transport agent may be “4” and the recipient may be “6.” The chain of custody code may then be used by a server in the command center 502 in the process of transmitting automatic status updates to team members to determine the recipients of each message.

Column 710 may contain GPS location data providing information about the current location of a party. For example, if the donor's cellular phone includes a GPS device, the command center 502 may be configured to receive location data from the GPS device and update the GPS location continuously, which may be stored in column 710. Column 712 may contain anticipated location data about where each party must be on the date of the transplant procedure. For example, the donor 208 may be expected to be present at Hospital A on the date of harvest while the recipient 308 may expected to be present at Hospital B on the same date. Columns 714 and 716 may contain expected arrival time and date data, respectively, representing when each party is expected to be present at the associated location in column 712. For example, data table 700 shows that the donor 208 is expected to be present at the harvesting Hospital A 202 at 6:00 AM on Jan. 1, 2011, while the recipient 308 is expected to be present at the transplant Hospital B 302 at 12:00 PM on Jan. 1, 2011. Column 718 may contain estimated time of arrival (ETA) to a destination data, indicating how long it will take a party to reach the associated location in column 712 or the time at which the party is expected to arrive at that location. The command center 502 may calculate the ETA to the destination based on the current location data received from a party's GPS device in conjunction with other information, such as map and routing software and databases like Google® Maps. For example, if the host surgeon is currently located at Hospital D the command center 502 may use a map software or website to determine the distance between the current location (i.e., Hospital D) and the anticipated location stored in column 712 (i.e., Hospital A), as well as the expected travel time via city streets. As shown in row 700b of the data table 700, the server maintaining the data table estimates that it will take the host surgeon about 3 hours to travel from Hospital D to Hospital A, as shown in the ETA to destination in row 700b, column 718. The ETA data may also be presented or maintained in time of day format, for example, if the current time is 1:00 PM and the estimated travel time of the surgeon is 3 hours, the ETA may be presented in column 718 as “4:00 PM”. Other data formats may be uses as well, as will be appreciated by those of ordinary skill in the art.

Column 720 may contain alert level data. The alert level data may represent information regarding the role and importance of the participant within the team for the purpose of coordinating automatic communications by the command center 502. For example, the command center 502 may send an SMS message every 5 minutes to individuals with an alert level of “1,” as is shown in row 700a, representing the donor. However, the command center 502 may send an SMS message only every 20 minutes to those individuals with an alert level of “4”, as is shown in row 700c, representing a transport pilot.

According to a preferred embodiment, the command center 502 may update the initial harvest/transplant plan data table 700 continuously to reflect newly received data. FIG. 6 illustrates an embodiment data table which has been updated by the command center 502 based on received data. In example data table 800, the original on-call host surgeon has been dismissed and replaced by the standby surgeon. In updating the harvest/transplant plan, the command center 502 may consider several parameters. For example, the command center 502 may determine that the current date is Jan. 1, 2011, and that the current time is 6:05 AM. The command center 502 may also determine that the on-call host surgeon is expected to be at Hospital A by 8:00 AM. The command center 502 may determine the location of the on-call host surgeon based on the surgeon's current GPS location stored in row 800b, column 710. Using the surgeon's location, the command center 502 may determine that the surgeon's ETA to destination is about 3 hours, stored in row 800b, column 718. Based on such data, the command center 502 may determine that the on-call host surgeon will arrive at Hospital A 202 at least one hour later than expected. The command center 502 may then update the harvest/transplant plan by deleting the on call host surgeon (i.e., John Fine) and replacing him with the standby surgeon, “Jackie Cutter.” As shown in row 800c, upon replacing “John Fine,” the status of “Jackie Cutter” may be updated as well. For example, the alert level in column 720 of “Jackie Cutter” may be raised from “5” (i.e., receive infrequent SMS messages) to “1”, meaning SMS messages will be sent to “Jackie Cutter” frequently, such as every 5 minutes, until the harvesting surgery is completed and the harvested organ leaves Hospital A 202. The command center 502 may communicate any updates to the harvest/transplant plan to other parties involved in the transplant process. In a preferred embodiment, the determinations, changes to the plan and communications described above may be performed automatically by one or more servers within in the command center 502, with only status updates provided to human coordinator. However, the amount of automation implemented in the command center 502 for accomplishing the tasks of the various embodiments may vary from implementation to implementation, from time to time, and from operator to operator.

Other types of data updates may also be implemented at each stage of the transplant evolution. For example, when the organ is harvested and picked up by the transport team, the alert level of those parties at Hospital A 202, stored in column 720, may be decreased or cancelled so those no longer involved in the processes will no longer receive SMS messages from the command center 502. At the same time, the alert level for the pilot may be increased and more SMS messages may be sent to the pilot once the harvested organ is picked up by the driver 1 404. Thus, the command center 502 may communicate and coordinate with the next party in the chain of custody without having to involve those who no longer have control over the organ. In an alternative embodiment, instead of revising the alert levels of individuals, a server in the command center 502 may use the chain of custody code stored in column 708 to suspend automatic messages to those parties no longer involved in the transplant evolution, or may use the chain of custody code in conjunction with each party's alert level to determine the distribution for each status message transmitted.

FIG. 7 illustrates a diagram of a chain of custody model for a single donor transplant process according to an embodiment. The example chain of custody model 900 may be used to provide a guide regarding the number and identity of those individuals who will have custody for the donated organ. Additionally, the times-of-day or durations of time during that each party is in possession of the organ may also be recorded for accountability. In the example chain of custody model 900, an organ may be harvested from the donor 208 by surgeon A 206 at Hospital A 202. The organ may be relinquished to a security guard A 210 who may give it to the ground transporter A 404. The ground transporter 404 may transport the organ to an air transporter A 406 who may transport the organ to the recipient's city. A second ground transporter B 408 may pick up the organ from the air transporter A and deliver it to a security guard B at hospital B 302. The security guard B 310 may deliver the organ to the operating room where the surgeon B 306 may transplant the organ into the recipient 308.

In an embodiment, a chain of custody plan may be created from the chain of custody model 900, as the data may be updated at blocks 902a-902i during the transportation of the harvested organ to reflect the actual times at which the organ changes hands. For example, at 8 AM at block 902a, the donor 208 may be the custodian of the organ as he is prepped for surgery. At 8:45 AM at block 902b, surgeon A 206 may remove the organ from the body of the donor 208, and at 8:55 AM at block 902c the security guard A 210 may pick it up. At 8:57 AM at block 902d, the security guard A may hand over the organ to the ground transporter A 404 who may drive it to the air transporter A 406. A hand-off may occur between the ground transporter A 404 and the air transporter A 406 at 9:15 AM at block 902e. The air transporter A 406 may deliver the organ to the second ground transporter B 408 at 10:30 AM at block 902f, who in turn may deliver the organ to the security guard B 310 at Hospital B 302 at 10:45 AM at block 902g. The security guard B 310 may deliver the organ to the surgeon B 306 at 12:00 PM at block 902h. The surgeon B 306 may transplant the organ into the recipient 308 at 12:45 PM at block 902i.

In another embodiment, each custodian in the chain of custody may be designated a code 902a-902i for identification purposed. For example, the donor 208 may be custodian 1; surgeon A 206 may be custodian 2; security guard A 210 may be custodian 3; ground transporter A 404 may be custodian 4; air transporter 406 may be custodian 5; ground transporter B may be custodian 6; security guard 310 may be custodian 7; surgeon B may be custodian 8; and the recipient may be custodian 9.

FIG. 8 illustrates a data table for a chain of custody plan monitoring the chain of custody of the organ and other data during an organ transport process, according to an embodiment. The example chain of custody data table 1000 may include information about the harvested organ of the donor A 208, “Chris Giving.” Column 902 may contain time data, storing the times at which the organ was passed from one custodian to another. For example, the surgeon may harvest the organ at 8:45 AM, and “8:45 AM” may be stored in row 1000b, column 902 at the time custody of the organ is transferred from the donor to surgeon A.

In a preferred embodiment, the organ may be placed in an organ transport device 10 and the command center 502 may receive data from the organ transport device sensors. Data received at the command center 502 may be stored in the data table 1000 to form a complete record of the transport and points in between. Organ transport device sensors may include, for example, temperature sensors to report the temperature at a certain time. Temperatures may be stored in column 1002 of data table 1000. For example, when the harvested organ is placed in the organ transport device 10, the temperature sensor may report a temperature of 3° C. to the command center 502, stored in row 1000a, column 1002. The command center 502 may also receive coordinates regarding the device GPS location, which may be stored in column 1004. Such coordinates may be converted by the command center 502 to a location such as “Hospital A.” For example, as shown in row 1000b, the device GPS location indicates that the device is located in Hospital A.

The command center 502 may further receive and record data from the device accelerometer, which may be stored in column 1006. The command center 502 may set an acceleration threshold beyond which damage may be caused to the transporting organ. Each organ type, such as brain, kidney, liver and blood may have a specific acceleration threshold beyond which damage to the organ may occur. This is because each organ may have a different tolerance for physical trauma. For example, as shown in row 1000b, column 1006, the acceleration data received from the device shows that by 8:54 AM there had not been any reportable acceleration exceeding the damage threshold.

The command center 502 may further receive signals from the lock sensor of the organ transport device and record data table 1000. This sensor determines the device lock status 1008 or senses when the transport device is opened. Thus, the device lock sensor may record every instant of opening and closing of the organ transport device 10. In combination with reporting time 902 and location data 1004, the chain of custody data table 1000 may track the time and location of every opening of the transport device. Such information may be very valuable in judging the acceptability of an organ for transplantation into a patient. This information may further allow the command center 502 and each custodian to determine whether the device has been tampered with or whether the security and integrity of the organ has been breached. Information may be reported to the command center 502 via a wireless data link, enabling the command center 502 to instantly alert various parties and components in the system, and store the information in the chain of custody data table 1000. For example, the command center 502 may instantly alert the transplant team and allow the transplant surgeon to decide whether to cancel the operation before the organ arrives, thereby reducing trauma to the recipient. Alerts to the parties and components of the system may be sent, for example, via SMS, email, etc.

The command center 502 may also receive alerts about critical data, which may be stored in column 1010 of data table 1000. Alerts may be generated by any component of the transplant system including the organ transport device 10. For example, as shown in row 1000a, column 1010, the blood pressure of the donor during the surgery was reported to be low at 85/50. As another example, in row 1000f, the alerts indicate that the air transporter A was 30 minutes early in the hand off of the organ from the air transport 406 to the ground transport B 408. The command center 502 may further receive data regarding the actual custodian of the organ at any time, which may be stored in column 1012. For example, as shown in row 1000b, column 1012, the surgeon A 206 is the custodian of the organ at 8:45 AM following the removal of the organ from the donor 208.

The command center 502 may receive notes sent by the custodians of the organ during the organ transport, which may be stored in column 1014. For example, as shown in row 1000b, column 1014, the surgeon A 206 may examine the organ upon harvesting and determine that it is a healthy organ before placing it into the organ transport device 10. The surgeon A 206 may communicate his or her findings to the command center 502 via an electronic message (e.g., email, SMS or voice mail), which may appear as notes in row 1000b, col. 1014 In addition to storing textual notes, the chain of custody data table may store voice and video files (not shown), thereby enabling custodians to make verbal reports (e.g., by telephone) and to send photographs and video (e.g., to show the condition of the organ upon harvesting). Also, custodians may enter their comments under the notes 1014 using different methods according to the various embodiments. For example, notes may be entered and received directly to the organ transport device 10, which may be equipped with, for example, a keyboard, display, microphone for receiving verbal notes, etc. These notes may then be transmitted from the organ transport device 10 to the command center 502 via a cellular network 604. The custodians may also use other methods to communicate their comments directly with the command center 502 by, for example, SMS, phone call, email, etc.

The chain of custody data table may be printed as a chain of custody document by the transplant surgeon before he or she transplants the received organ into the recipient. The transplant surgeon may study the chain of custody document to determine whether any errors have occurred during the transport of the organ. By recording this information in a document format presented to the surgeon along with the organ, the transplant surgical team may verify that the organ has been properly treated before placing it into the recipient's body. For example, the transplant team may ensure that the received organ is healthy and delivered following all the required protocols.

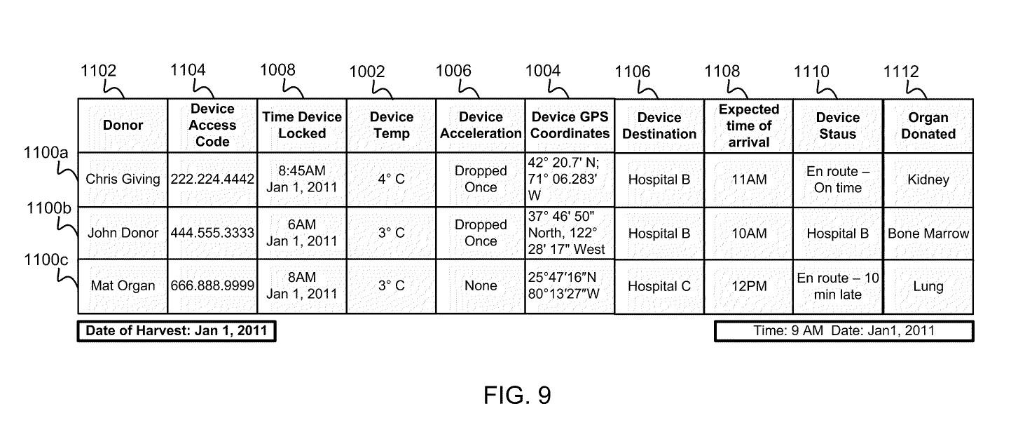

FIG. 9 illustrates a data table of selected information about all the organ transplant processes that are being managed by the command center 502 according to an embodiment. For example, data table 1100 may store information on three transplants occurring on one day (i.e., Jan. 1, 2011), each involving different donors and recipients. As shown in rows 1100a, 1100b and 1100c of data table 1100, the three organ donations may all occur at different times. For example, information associated with one of the transplants is stored in row 1100a. The donor in this example transplant is named Chris Giving, in column 1102, and the organ donated is a kidney, in column 1112. The kidney was placed in the organ transport device 10 and the device was locked at 8:45 AM on Jan. 1, 2011, in column 1008. The specific organ transport device 10 carrying the harvested kidney has a device access code 1102 of “222.224.4442”, in column 1104. The current temperature of the organ transport device is 4° C., in column 1002, based on the data received from the device's 10 thermometer, and the device 10 has been dropped one time, in column 1006, based on the data received from the device's 10 accelerometer. The GPS coordinates of the organ transport device 10 are 42° 20.7′ N; 71° 06.283′ W, in column 1004, based on data received from the device's 10 GPS receiver. The destination of the device is Hospital B, in column 1106, and the kidney must arrive at that destination at 11:00 AM, in column 1108. The organ transport device 10 status indicates that it is “en route” and will arrive to the destination “on time”, in column 1110. The time of arrival and any delays that may be expected may be calculated at the command center 502 using the GPS data received from the organ transport device 10.

In an embodiment, the data tables described above with reference to FIGS. 5, 6, 8 and 9 may be displayed through a graphical user interface to users with access to a computer display screen. Users may also be able to print these documents for their records. In a further embodiment, the data tables may be formatted in a size and form suitable for presentation and review on a mobile device such as a cellular telephone or tablet computer. In a further embodiment, the system may print out a variety of error logs and custom reports, either periodically or on-demand.

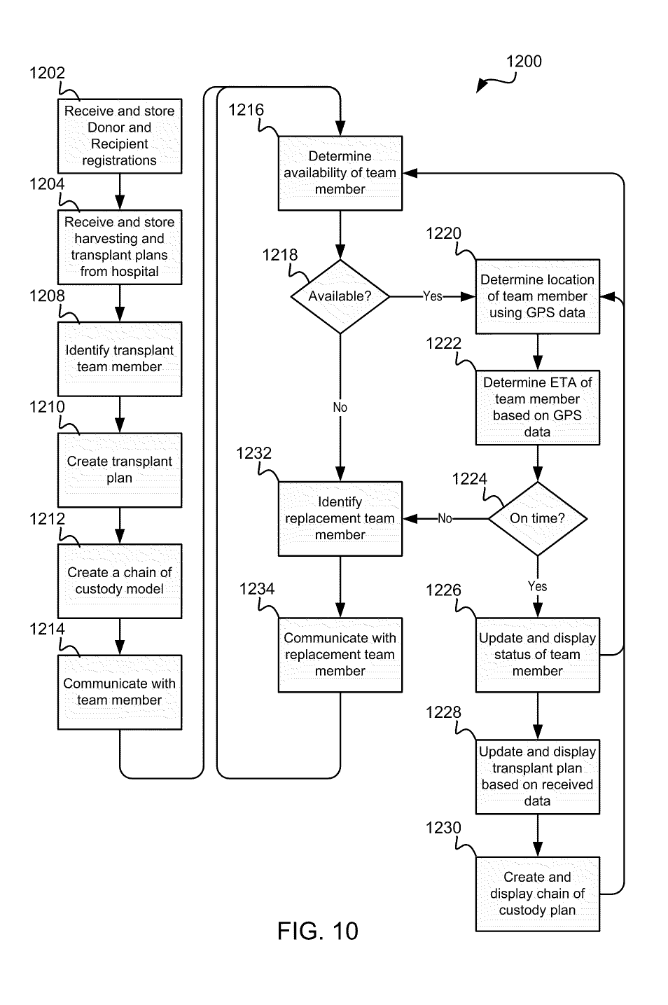

FIG. 10 illustrates an embodiment method for managing and monitoring a harvest/transplant process of an organ. In method 1200, a command center 502 server may be configured to receive and store information from different components of the transplant process. The command center 502 server may receive and store donor 208 and recipient 308 registration information from Hospital A 202 and Hospital B 302, step 1202. The command center 502 server may also receive and store harvesting and transplant plans from the Hospital A and Hospital B transplant coordinators 204, 304, step 1204.

The command center 502 server may use the data received from Hospitals A and B 202, 302 to identify transplant team members, step 1208, and create a harvest/transplant plan, step 1210. The harvest/transplant plan created in step 1210 may be used by different components and participants within the transplant system to coordinate and manage the transportation process. In an embodiment, the harvest/transplant plan may be customized based on user preferences, for example, changing the parameters included in the harvest/transplant plan.

The command center 502 server may create a chain of custody model 900, step 1212. As described above, the chain of custody model 900 may be used to track the transport of an organ from the point of origin to its final destination. The chain of custody model 900 may also be customizable based on user preferences and the circumstances unique to a particular organ transplant evolution. Users may elect to delete or add data from the chain of custody model 900 depending on the way the users prefer to manage the transplant process.

The command center 502 server may determine the availability of different team members involved in a transplant process, step 1216. For example, as the time to harvesting an organ approaches, the command center 502 server may monitor all team members to ensure they will be available for the harvesting, transport and transplant of the organ. Determining availability may include communicating with each member to ensure that they will be available by using communication methods such as, for example, SMS or email. The command center 502 server may be configured to intensify the level of communication with team members as the time for their services approaches, for example, by increasing the frequency of SMS messages to a harvesting surgeon one hour prior the surgery in comparison to one day prior to the harvesting operation.

If the team member is available (i.e., determination 1218=“Yes”), the command center 502 server may determine the location of the team member using GPS data received from a device carried by the team member, such as cellular phone, step 1220. The command center 502 server may determine the estimated time of arrival of the team member to the anticipated location 714 based on the received GPS sensor data, step 1222, and determine whether the team member will arrive at the anticipated location on time, determination 1224.

If the team member will arrive at the anticipated location 714 on time (i.e., determination 1224=“Yes”), the command center 502 server may update and display the status of the team member, step 1226, and continue to periodically determine the availability of the team member until the team member fulfils his or her role in the transplant process, by returning to step 1216. Based on the received data, the command center 502 server may also update and display the harvest/transplant plan, 1228, and create and display a chain of custody plan, step 1230.

If a team member is not available (i.e., determination 1218=“No”), the command center 520 server may identify a replacement team member, step 1232, and begin communicating with the replacement team member, step 1234. The command center 502 may determine the availability of the replacement team member to participate in the transplant by returning to step 1216. Once a replacement team member is identified, the command center 502 may monitor and manage their availability by communicating with them and determining their GPS location and their estimated time of arrival to the anticipated location 714, step 1216.

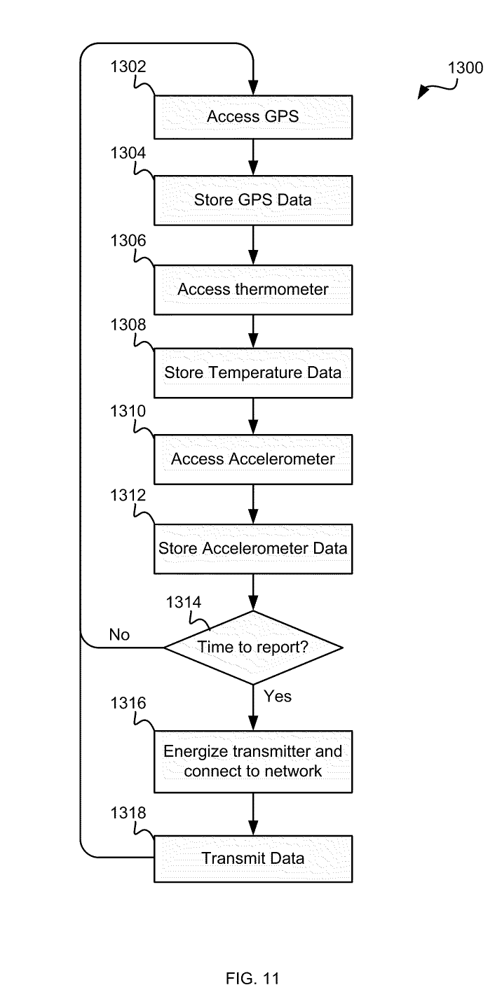

FIG. 11 illustrates an embodiment method that may be implemented in a processor in an organ transport device 10 for transmitting data to the command center 502. In method 1300, the organ transport device 10 processor may access a GPS receiver, step 1302, and may store GPS data, step 1304. The organ transport device 10 processor may access a thermometer sensor, step 1306, and may store temperature data, step 1308. The organ transport device 10 processor may access an accelerometer, step 1310, and may store acceleration data, 1312. The organ transport device 10 processor may periodically report the data stored to the command center 502 via a wireless communication link by determining whether it is time to report data, determination 1314. If it is time to report data (i.e., determination 1314=“Yes”), the organ transport device 10 processor may energize a wireless transmitter and connect to an available wireless communication network, step 1316, and transmit the data, step 1318. The organ transport device 10 processor may be configured to determine which of a variety of wireless data networks are available (e.g., WiFi, cellular, WiMax, etc.). If it is not time to report data (i.e., determination 1314=“No”), the organ transport device 10 processor may continue to monitor the sensors and store their data, returning to step 1302. This process may continue to repeat continuously from the time the organ is placed in the transport device until the time it is removed. In alternative embodiments, reporting of stored data may occur continuously or instantaneously (not shown), depending on the system configuration, as opposed to periodically.

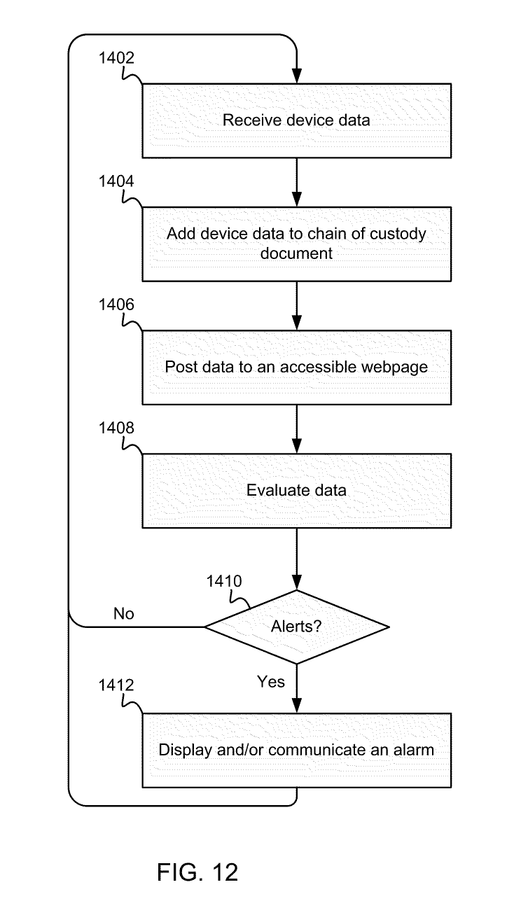

FIG. 12 illustrates an embodiment method for managing data received from the organ transport device 10. In method 1400, the command center 502 server may receive transmitted data from an organ transport device 10 via a network, such as the Internet 602 or a cellular data network 604, step 1402. The command center 502 server may unpack reported data from received messages and add the device data to the chain of custody data table, step 1404. The command center 502 server may post the received data (or the updated chain of custody data table) on an Internet webpage, step 1406. In this manner, the latest organ transport condition data may be readily available to the entire transplant team.

The command center 502 server may evaluate the received data (e.g., comparing data to acceptable thresholds or to prior data reports), step 1408, and may determine whether there are any alerts that should be recorded and/or reported to team members, determination 1410. Alerts may include, for example, buttons or other inputs that custodians may activate to cause transmission of an alarm message to the command center 502. Alerts may also include, for example, automatic alarm messages generated when sensor readings from the organ transport device 10 go outside pre-configured alarm thresholds. If the server determines or detects an alert condition (i.e., determination 1410=“Yes”), the command center 502 server may display an alarm on a console of the command center 502 and/or transmit an alarm message to appropriate members of the transplant team, step 1412. For example, if the data received from the thermometer sensor of an organ transport device 10 indicates a temperature below or above a predetermined acceptable range for the type of organ being transported, the command center 502 server may identify that discrepancy and generate an alarm to notify the appropriate team members (e.g., the transplant surgeon and the recipient family) about possible damage to the harvested organ. If the server does not detect an alarm or alert condition (i.e., determination 1410=“No”), the command center 502 server may await the next organ transport device 10 data transmission, returning to step 1402.

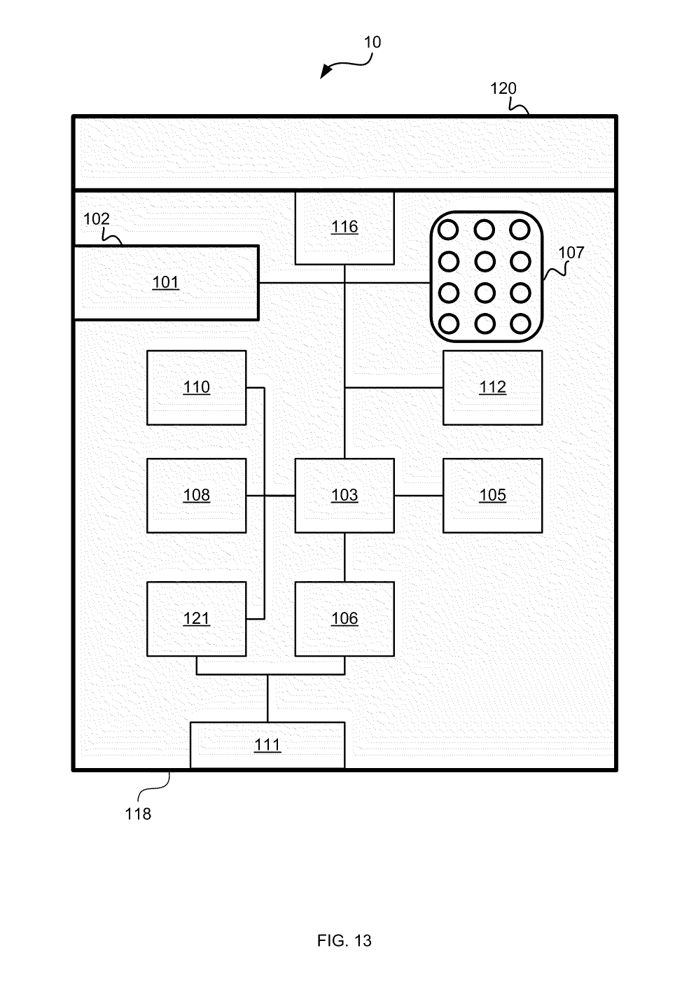

The embodiments described above may be implemented on any of a variety of organ transport devices 10. Typically, such organ transport devices 10 will include some or all of the components illustrated in FIG. 13. For example, the organ transport device 10 may include a case or housing 118 and a top 120. The organ transport device 10 may further include a processor 103 coupled to internal memory 105 and a touch surface input device 101 or display 104. The touch surface input device 101 may be any type of touchscreen display 102, such as a resistive-sensing touchscreen, capacitive-sensing touchscreen, infrared sensing touchscreen, acoustic/piezoelectric sensing touchscreen, or the like. Additionally, the organ transport devices 10 may have an antenna 111 for sending and receiving electromagnetic radiation that is connected to a wireless data link and/or cellular telephone transceiver 106 coupled to the processor 103. The antenna 111 may also be coupled to a GPS receiver 121 that is also coupled the processor 103. Organ transport devices 10 which do not include a touchscreen display 101 may include a key pad 107 or miniature keyboard for receiving a custodian input. The processor 103 may further be connected to a thermometer sensor 108, an accelerometer 110, a chemical sensor 112, a timer 114 and a lock sensor 116, as well as other sensors (not shown).

The data-logging device 91 may be a programmable processor that is configured with processor executable instructions to perform a variety of operations, including recording security status information, counting down remaining time until an expected arrival time at a destination location, determining a current location of the organ transport device, and transmitting the security status information, remaining time, and current location over wired or wireless data links.

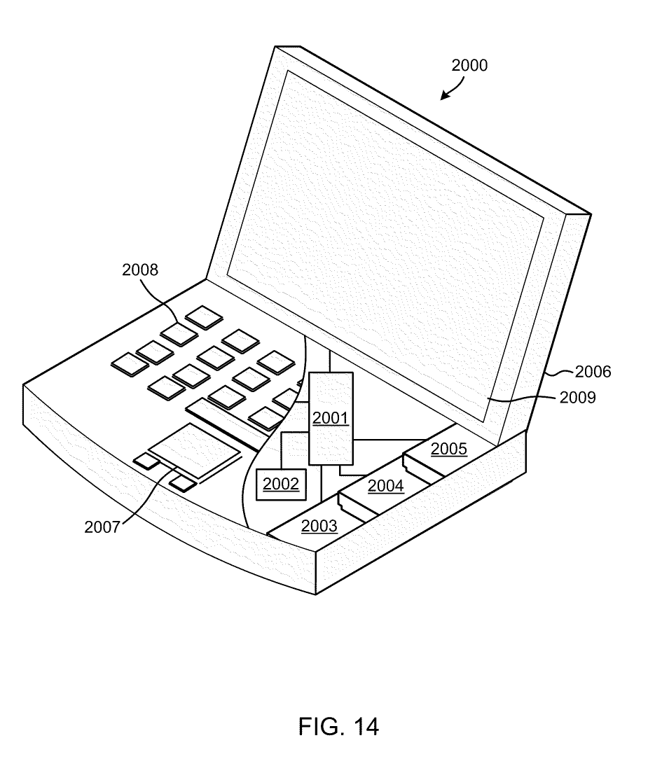

A number of the embodiments described above may also be implemented with any of a variety of computing devices, such as a notebook computer 2000 illustrated in FIG. 14. Such a notebook computer 2000 typically includes a housing 2466 that contains a processor 2001 coupled to volatile memory 2002 and to a large capacity nonvolatile memory, such as a disk drive 2003. The computer 2000 may also include a floppy disc drive 2004 and a compact disc (CD) drive 2005 coupled to the processor 2001. The computer housing 2006 typically also includes a touchpad 2007, keyboard 2008, and the display 2009.

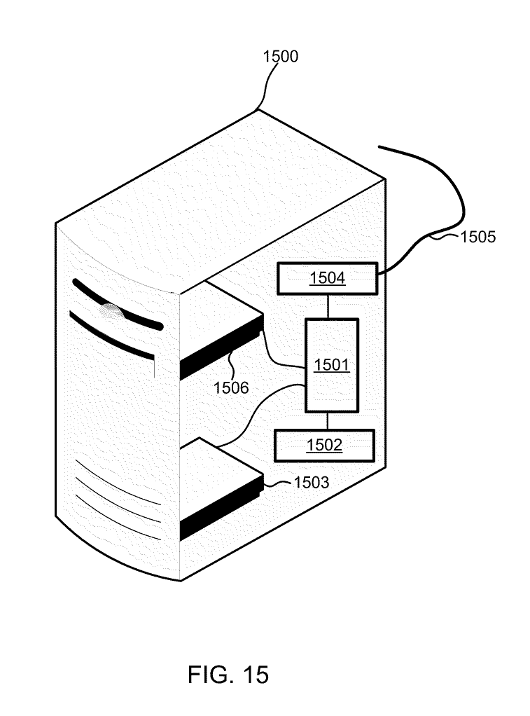

A number of the embodiments described above may also be implemented with any of a variety of remote server devices, such as the server 1500 illustrated in FIG. 15. Such a server 1500 typically includes a processor 1501 coupled to volatile memory 1502 and a large capacity nonvolatile memory, such as a disk drive 1503. The server 1500 may also include a floppy disc drive and/or a compact disc (CD) drive 1506 coupled to the processor 1501. The server 1500 may also include a number of connector ports 1504 coupled to the processor 1501 for establishing data connections with network circuits 1505.

The computing device processor 103, 1401, 1501 may be any programmable microprocessor, microcomputer or multiple processor chip or chips that can be configured by software instructions (applications) to perform a variety of functions, including the functions of the various embodiments described above. In some organ transport devices 10, multiple processors 103, 2001 may be provided, such as one processor dedicated to wireless communication functions and one processor dedicated to running other applications. The processor may also be included as part of a communication chipset.

The various embodiments may be implemented by a computer processor 301, 2001, 1501 executing software instructions configured to implement one or more of the described methods or processes. Such software instructions may be stored in memory 105, 2005, 1502, in hard disc memory 2003, on tangible storage medium or on servers accessible via a network (not shown) as separate applications, or as compiled software implementing an embodiment method or process. Further, the software instructions may be stored on any form of tangible processor-readable memory, including: a random access memory 105, 2005, 1502, hard disc memory 2003, a floppy disk (readable in a floppy disc drive 2004), a compact disc (readable in a CD drive 2005), electrically erasable/programmable read only memory (EEPROM), read only memory (such as FLASH memory), and/or a memory module (not shown) plugged into the organ transport device 10 such as an external memory chip or USB-connectable external memory (e.g., a “flash drive”) plugged into a USB network port. For the purposes of this description, the term memory refers to all memory accessible by the processor 103, 2001, 1501 including memory within the processor 103, 2001, 1501 itself.

The foregoing method descriptions and the process flow diagrams are provided merely as illustrative examples and are not intended to require or imply that the processes of the various embodiments must be performed in the order presented. As will be appreciated by one of skill in the art the order of blocks and processes in the foregoing embodiments may be performed in any order. Words such as “thereafter,” “then,” “next,” etc. are not intended to limit the order of the processes; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm processes described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some processes or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The processes of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions stored on a machine readable medium and/or computer-readable medium, which may be incorporated into a computer program product.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein, and instead the claims should be accorded the widest scope consistent with the principles and novel features disclosed herein.

What is claimed is:

1. A method for managing an organ transplant process, comprising:
receiving transplant process data in a central server;
identifying members of a transplant team based on the received data;
identifying members of a harvesting team based on the received data;
identifying members of a transport team based on the received data;
creating a harvest/transplant plan based on the received data; and
creating a chain of custody model based on the received data
identifying unfavorable issues based upon data received
providing management reports, which document errors, workflow, missing information and time management.

2. The method of claim 1, further comprising:
receiving reports regarding the transplant process in the central server;
communicating with members of the transplant team and members of the harvesting team;
updating the harvest/transplant plan, wherein updates are based on received reports regarding the transplant process and communications with the members of the transplant team and the harvesting team; and
displaying an updated harvest/transplant plan.

3. The method of claim 2, wherein:
receiving reports regarding the transplant process comprises receiving in the central server periodic status notifications by at least one of SMS messages, emails and telephone calls; and
communicating with members of the transplant team and the harvesting team comprises sending and receiving at least one of SMS messages, emails, telephone calls, and Internet webpage updates.

4. The method of claim 1, further comprising:
receiving reports regarding the transport process in the central server;
communicating with members of the transport team;
storing data from the chain of custody model in a chain of custody data table in the central server;
updating the chain of custody data table based on new chain of custody data, wherein the new chain of custody data comprises data received from an organ transport device and data received from communicating with the members of the transport team;
creating a chain of custody plan based on the chain of custody data table; and
displaying the chain of custody plan.

5. The method of claim 4, wherein:
receiving reports regarding the transport process comprises receiving periodic status notifications by at least one of SMS messages, emails and telephone calls; and
communicating with members of the transport team comprises sending and receiving at least one of SMS messages, emails, telephone calls, and Internet webpage updates.

6. The method of claim 3, wherein updating the harvest/transplant plan comprises:
periodically determining availability of the members of the transplant team based on the communications;
periodically determining current locations of the members of the transplant team based on GPS coordinates, wherein the GPS coordinates are received from mobile devices associated with the members of the transplant team;
computing estimated times of arrival of the members of the transplant team based on the determined current locations; and
identifying replacement members if the members of the transplant team are not available or if the estimated times of arrival are after a required time of arrival.

7. The method of claim 6, wherein identifying replacement members of the transplant team is performed automatically based on pre-stored availability data, the method further comprising automatically providing notice to the transplant team when a member is replaced.

8. The method of claim 4, wherein updating the chain of custody data table comprises:
identifying a custodian of the organ transport device based on a transportation route;
determining availability of the custodian based on communications with the custodian;
periodically determining status information of an organ based on data received from the organ transport device;
periodically computing a current location of the organ based on GPS coordinates, wherein the GPS coordinates are received from the organ transport device;
computing an estimated time of arrival based on the current location of the organ transport device; and
identifying a replacement transportation route of the organ transport device if the custodian is unavailable or if the estimated time of arrival is after a required time of arrival.

9. The method of claim 8, wherein identifying a replacement transportation route of the organ transport device is performed automatically based on pre-stored transportation options.

10. The method of claim 2, wherein the harvest/transplant plan comprises:
a name of at least one participant in the organ transplant process;
contact information associated with the at least one participant; and
a role of the at least one participant in the organ transplant process.

11. The method of claim 10, wherein the harvest/transplant plan further comprises a chain of custody code associated with the at least one participant, wherein the chain of custody code is based on a temporal sequence of the chain of custody model.

12. The method of claim 10, wherein the harvest/transplant plan further comprises:
a current location of the at least one participant, wherein the location is based on GPS coordinates received from a mobile device associated with the at least one participant;
an anticipated location associated with the at least one participant; and
an expected time of arrival at the anticipated location for the at least one participant.

13. The method of claim 12, wherein the harvest/transplant plan further comprises an estimated time of arrival for the at least one participant, wherein the estimated time of arrival is based on the distance between the current location and the anticipated location.

14. The method of claim 10, wherein the harvest/transplant plan further comprises an alert level associated with the at least one participant, wherein the alert level is based on the importance of the role of the at least one participant in the organ transplant process.

15. The method of claim 14, wherein frequency of communications with the at least one participant is based on the alert level associated with the at least one participant.

16. The method of claim 4, wherein the chain of custody data table comprises:
at least one time entry, wherein the time is during a scheduled transportation of the organ transport device;
a current destination of the organ transport device;
a custodian of the organ transport device associated with the at least one time entry; and
data received from the organ transport device, wherein the data is recorded at the time of the at least one time entry.

17. The method of claim 16, wherein the data received from the organ transport device comprises at least one of a temperature measurement, an acceleration measurement, a lock status, an alert, GPS coordinates and notes entered by the custodian.

18. The method of claim 17, further comprising:
determining a current location of an organ transport device based on the GPS coordinates received;
determining a time of arrival at the current location; and
automatically determining a transportation route based on the time of arrival.

19. An medical transport device, comprising:
an outer case;
an insulating layer;
a waterproof open well inside the insulating layer;
an insulating lid hingedly attached to the outer case;
a processor;
a lock sensor coupled to the processor, wherein the lock sensor is configured to sense security status parameters;
a timer coupled to the processor;
a wireless transmitter coupled to the processor; and
a GPS receiver coupled to the processor,
wherein the processor is configured with processor-executable instructions to perform operations comprising:
recording security status information;
counting down remaining time until an expected arrival time at a destination location;
determining a current location of the organ transport device; and
transmitting the security status information, remaining time, and current location over wireless data links.

20. The organ transport device of claim 19, further comprising:
a temperature data-logging device coupled to the processor,
wherein the processor is configured with processor-executable instructions to perform operations further comprising:
recording temperature data, wherein the temperature data comprises measurements of temperature of the inner caddy; and
representing the temperature data in a graph of temperature over time.

21. The organ transport device of claim 19, further comprising:
a touchscreen coupled to the processor,
wherein the processor is configured with processor-executable instructions to perform operations further comprising receiving input notes from the touchscreen.

22. The organ transport device of claim 19, further comprising:
a keypad coupled to the processor,
wherein the processor is configured with processor-executable instructions to perform operations further comprising receiving input notes from the onfigured to receive input notes.

23. The organ transport device of claim 19, wherein the processor is configured with processor-executable instructions to perform operations such that recording security status information comprises:
recording each instance of opening the organ transport device; and
recording each instance of closing the organ transport device.

24. The organ transport device of claim 20, wherein the processor is configured with processor-executable instructions further comprising:
establishing a wireless network connection with a computing device; and
uploading the temperature data to the computing device over the wireless network connection.

25. An organ transplant communication system, comprising:
a communication network;
a command center comprising one or more servers connected to the communications network;
one or more hospital servers connected to the communications network; and
one or more mobile devices connected to the communications network, wherein each of the one or more mobile devices is associated with a participant of an organ transplant process; and
an organ transport device, comprising:
an outer case;
an insulating layer;
a waterproof open well inside the insulating layer;
an insulating lid hingedly attached to the outer case;
a processor;
a lock sensor coupled to the processor, wherein the lock sensor is configured to sense security status parameters;
an accelerometer coupled to the processor;
a temperature sensor coupled to the processor and configured to measure temperature in the waterproof open well;
a wireless transmitter coupled to the processor; and
a GPS receiver coupled to the processor,
wherein the processor is configured with processor-executable instructions to perform operations comprising:
recording security status information;
obtaining GPS location information from the GPS receiver;
recording acceleration data received from the accelerometer;
determining a current location of the organ transport device;
determining a current temperature in the waterproof open well; and
transmitting the security status information, accelerometer data, temperature data, and current location over wireless data links to the command center,
wherein the command center is configured to send information to and receive information from the organ transport device, the first hospital server, the second hospital server, and the one or more mobile devices.

26. The organ transplant communication system of claim 25, wherein:
the command center is further configured to create a harvest plan and a transplant plan for the organ transplant process,
the harvesting plan comprising data on at least one of a type of surgery to be performed, an organ donor's name, an organ donor's contact information, names of members of a harvesting team, contact information for members of a harvesting team, names of members of a security team, contact information for members of a security team, a date and time planned for an organ harvest surgery, and a location and time for a transport team to take custody of a harvested organ, and
the transplant plan comprising data on at least one of a type of surgery to be performed, an organ recipient's name, an organ recipient's contact information, names of members of a transplant team, contact information for members of a transplant team, names of members of a security team, contact information for members of a security team, and a date and time planned for an organ transplant surgery; and
the harvest and transplant plans are based on a harvesting plan received from the donor hospital server and a transplant plan received from the recipient hospital server.

27. The organ transplant communication system of claim 26, wherein the command center is further configured to:
receive data from the one or more mobile devices; and
update the harvest and transplant plans based on the data received.

28. The organ transplant communication system of claim 26, wherein the command center is further configured to:
host an Internet webpage; and
post updates to the harvest and transplant plans on the Internet webpage, wherein participants of the organ transplant procedure access the Internet webpage to view updates.

29. The organ transplant communication system of claim 28, wherein:
the command center is further configured to create a chain of custody model for the organ transplant process, the chain of custody model being based on data received from the donor hospital server and data received from the recipient hospital server.

30. The organ transplant communication system of claim 30, wherein the command center is further configured to post updates to the chain of custody plan to an Internet webpage to enable participants of the organ transplant procedure to view the updates.

31. The organ transplant communication system of claim 29, wherein the command center is further configured to:
store data from the chain of custody model in a chain of custody data table;
update the chain of custody data table based on new chain of custody data, wherein the new chain of custody data comprises data received from the organ transport device and data received from the one or more mobile devices; and
create a chain of custody plan based on the chain of custody data table.

32. The organ transplant communication system of claim 25, wherein the command center is further configured to:
compare the data received from the organ transport device to pre-stored alert threshold values;
determine if an alert condition exists; and
communicate an alarm to the command center if it is determined that an alert condition exists.

33. The organ transplant communication system of claim 25, wherein the command center is further configured to:
periodically transmit messages to the one or more mobile devices; and
periodically receive response messages from the one or more mobile devices, wherein the messages and response messages are at least one of SMS messages, email messages, and voice messages.

34. The organ transplant communication system of claim 25, wherein the command center is further configured to:
Provide customer service for items and services listed but not limited to organ device consisting of, temperature monitoring and location tracking
Provide processor-executable instructions to address, solve or escalate such customer service issues
